(19) United States
(12) Patent Application Publication
(10) Pub. No.: US 2008/0314301 A1
(43) Pub. Date: Dec. 25, 2008

(54) Fertilizer Coulter With Self Sealing Knife

(76) Inventors: Patrick Whalen, Colchester, IL (US); Don Bunnell, Bowen, IL (US); Jim Lascelles, Ipava, IL (US); Lonnie Lucas, Colchester, IL (US); Derek Litchfield, Macomb, IL (US); Derek Allensworth, Blandinsville, IL (US)

Correspondence Address: BARNES & THORNBURG LLP, P.O. BOX 2786, CHICAGO, IL, 60690-2786, US

(21) Appl. No.: 12/145,205

(22) Filed: Jun. 24, 2008

Related U.S. Application Data
(60) Provisional application No. 60/946,051, filed on Jun. 25, 2007.

(51) Int. Cl. A01C 23/02

(52) U.S. Cl. 111/121; 111/118

(57) ABSTRACT

A soil treatment dispensing assembly that is provided with a frame and a coulter wheel coupled to the frame that is adapted to engage the soil to form a trench. The soil treatment dispensing assembly is also provided with a support arm having a leading edge adapted to engage the soil. The support arm includes a tubular applicator that is coupled to the lower portion of the support arm. The applicator includes a tapered forward region, a dispensing opening and an internal cavity formed in the applicator. The soil treatment dispensing assembly also includes an application conduit arranged to terminate within the internal cavity of the applicator. The application conduit is connectable to a source of treating product, such as fertilizer, and communicates the treating product directly into the internal cavity of the applicator. Treating product within the internal cavity exits the opening formed in the applicator to treat the soil.

### BACKGROUND

The present disclosure relates to the field of agricultural implements drawn by motive power sources such as tractors and is used to incorporate various liquid or granular preparations into the soil. More particularly, the present disclosure relates to a coulter trailed by a knife, which knife has attached to its trailing portion a tube through which liquid or granular fertilizer is dispensed into the soil.

Soil fertilization or other soil treatment is a method of improving soil quality with a view towards improving soil fertility. Fertilization improves crop yield and provides additional income and profit for farmers. Plants need various elements in order to grow and people have known for hundreds of years of the need to improve the quality of the soil. Nitrogen is the element in the soil that is most often lacking. Phosphorus and potassium are also needed in substantial amounts. Fertilizer coulters are used to add nitrogen, phosphorus and potassium to the soil.

Continuous no-till farming is the most effective and practical approach for restoring and improving soil quality which is vital for sustained food production and a healthy environment. With this way of farming, crop residues or other organic amenities are retained on the soil surface and sowing/fertilizing is done with minimal soil disturbance. Research and farmers' experience indicate that with continuous no-till farming, soil organic matter increases, soil structure improves, soil erosion is controlled, and in time crop yields increase substantially from what they were under tillage management, due to improved water relations and nutrient availability. Fertilizer coulters allow farmers to provide nutrients to the soil with minimal soil disturbance to improve soil quality and reduce erosion.

### SUMMARY

In accordance with the present disclosure, a coulter with a self sealing knife is provided to be drawn by a motive power source such as a tractor and used to dispense various liquid or granular preparations into the soil.

In illustrative embodiments, the fertilizer or other soil treatment dispensing assembly includes a frame and a coulter wheel coupled to the frame that is adapted to engage the soil to form a trench. The soil treatment dispensing assembly also includes a support arm having a leading edge adapted to engage the soil. The support arm includes a cylindrical applicator that is attached to the lower portion of the support arm. The applicator includes a tapered forward region, a dispensing opening and an internal cavity formed in the applicator that is in fluid communication with the dispensing opening. The fertilizer dispensing assembly also includes an application conduit arranged to communicate with the internal cavity of the applicator. The application conduit is connectable to a source of treating product, such as fertilizer, and communicates the treating product directly into the internal cavity of the applicator. Treating product within the internal cavity exits the opening formed in the applicator to treat the soil. The dispensing assembly causes very little soil disturbance and can be used for no-till farming.

Additional features of the disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a soil treatment dispensing assembly adapted to be coupled to a motive source such as a tractor and showing a coulter wheel coupled to the frame and a vertical support arm positioned behind the coulter wheel between a pair of gage wheels, the vertical support arm having a bullet-shaped applicator at its lower end;

FIG. 2 is another perspective view of the soil treatment dispensing assembly of FIG. 1 with one of the gage wheels removed to show the vertical support arm coupled to an adjustable bracket which in turn is coupled to the frame and further showing an application conduit positioned along the rearward edge of the support arm leading into the bullet-shaped applicator;

FIG. 3 is a rear view of the soil treatment dispensing assembly showing the vertical support arm positioned between the pair of gage wheels and also showing an internal cavity formed in the bullet-shaped applicator with the application conduit terminating within the cavity;

FIG. 4 is a front view of the soil treatment dispensing assembly showing the coulter wheel coupled to the frame and positioned in front of the vertical support arm, the bullet-shaped applicator, and the gage wheels;

FIG. 5 is a partial cross sectional view showing the vertical support arm positioned within an internal cavity formed within the bullet-shaped applicator and further showing the application conduit extending along the rearward edge of the vertical support arm and terminating within the internal cavity of the bullet-shaped applicator;

FIG. 6 is a perspective view of the bullet-shaped applicator having a conical nose portion and formed to include an elongated slot that is adapted to accept the support arm;

FIG. 7 is a perspective view of another embodiment of the applicator having a wedged shaped forward region and a pair of upswept wings extending along the length of the applicator;

FIG. 8 is a perspective view of another embodiment of the applicator having an oval housing;

FIG. 9 is a perspective view of another embodiment of the applicator having a curved top wall and flat side walls;

FIG. 10 is a perspective view of the support arm;

FIG. 11 is a perspective view of another embodiment of the support arm;

FIG. 12 is a perspective view of another embodiment of the soil treatment dispensing assembly showing a vertical support arm coupled to an applicator located at the lower end of the arm and also showing an application conduit extending along the rearward edge of the arm toward the applicator;

FIG. 13 is a rear view of the vertical support arm of FIG. 12 showing the applicator and the application conduit extending downwardly toward the applicator, the arrows indicating the direction of liquid flow;

FIG. 14 is a top perspective view of the soil treatment dispensing assembly showing a pair of soil disruption wheels positioned side by side and a seal wheel positioned behind the soil disruption wheel, the arrow indicating the direction of movement of the soil treatment dispensing assembly;

FIG. 15 is a perspective view of the soil treatment dispensing assembly showing a pair of gage wheels followed by a coulter wheel and also showing a vertical support arm positioned behind the coulter wheel and also showing a pair of soil disruption wheels and seal wheel positioned behind the vertical support arm;

FIG. 16 is a rear perspective view of the soil treatment dispensing assembly;

FIG. 17 is a side elevational view of the soil treatment dispensing assembly;

FIG. 18 is a perspective view of the soil treatment dispensing assembly with one of the gage wheels and one of the soil disruption wheels removed to show the coulter wheel and the vertical support arm;

FIG. 19 is a front elevational view of the soil treatment dispensing assembly showing the gage wheels and coulter wheel positioned in front of the vertical support arm;

FIG. 20 is a rear elevational view of the soil treatment dispensing assembly showing the seal wheel and the soil disruption wheels positioned behind the vertical support arm;

FIG. 21 is a side view of a knife for use with a soil treatment dispensing assembly; and

FIG. 22 is a perspective view of the soil treatment dispensing assembly used with the knife of FIG. 21.

### DETAILED DESCRIPTION

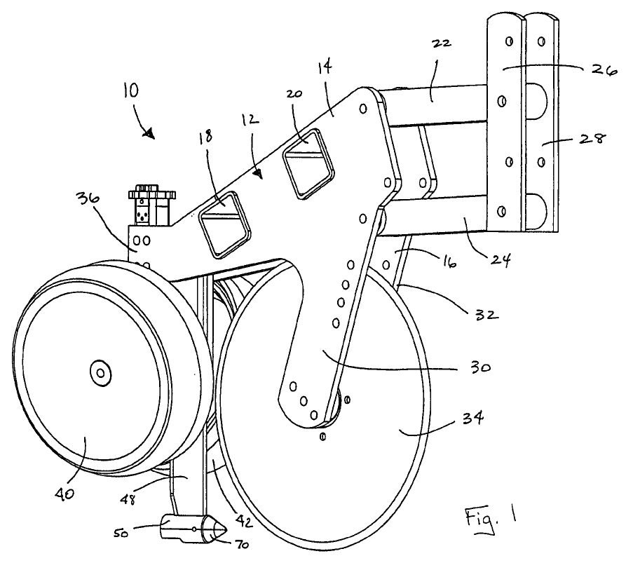

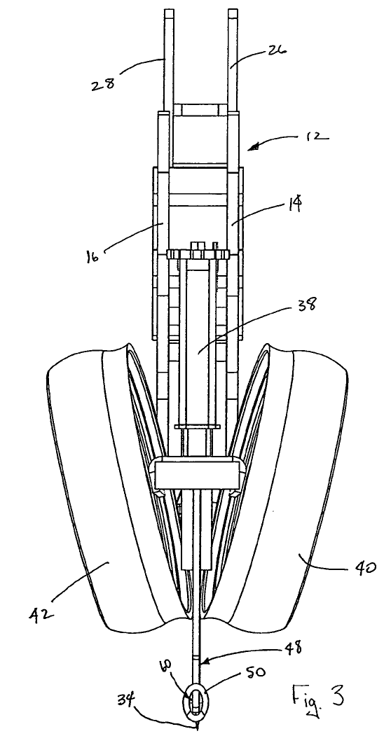

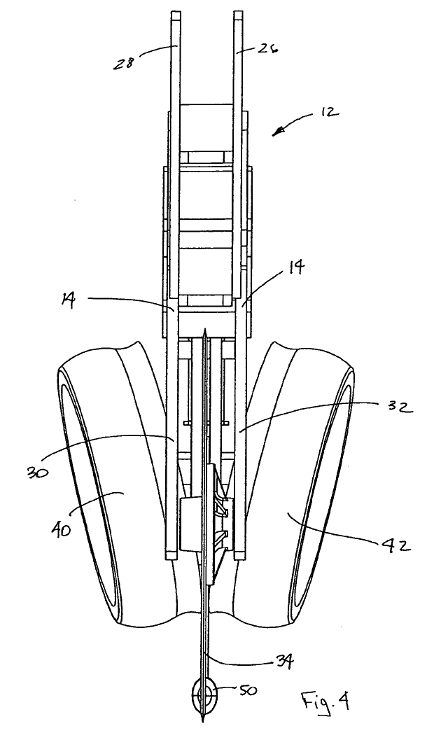

In the embodiment illustrated in FIGS. 1-11, the soil treatment dispensing assembly 10 includes a frame 12 having a first frame member 14 spaced apart from a second frame member 16. Frame members 14 and 16 are interconnected by first and second interconnecting members 18, 20. Frame 12 also includes first and second parallel support links 22, 24. Support links 22, 24 are connected to frame 12 at a first end and to a pair of support brackets 26, 28 at a second end. First and second frame members 14, 16 include first and second coulter support arms 30, 32. Coulter wheel 34 is rotatably coupled to coulter support arm 30, 32.

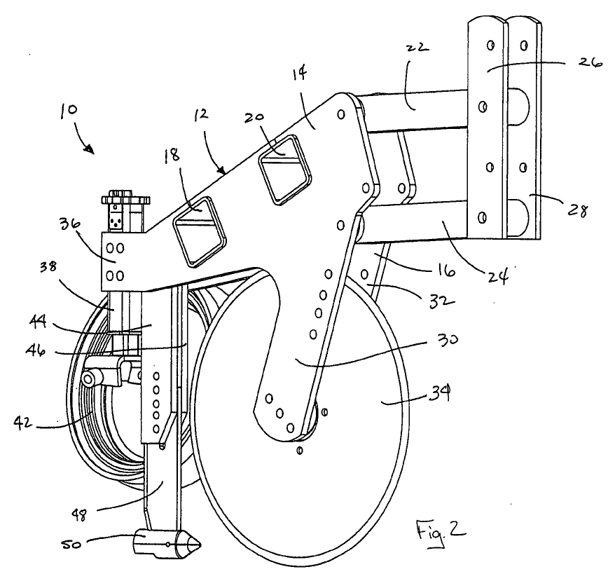

Frame 12 also includes a rear support 36 that is adapted to be coupled to gage wheel support bracket 38, as shown, for example, in FIG. 2. Gage wheel support bracket 38 is adapted to be coupled to gage wheels 40, 42. Gage wheels 40, 42 are positioned behind coulter wheel 34 and are adapted to close the trench formed in the soil by coulter wheel 34. Gage wheels 40, 42 are cambered to engage and force displaced soil back into the trench created by coulter wheel 34.

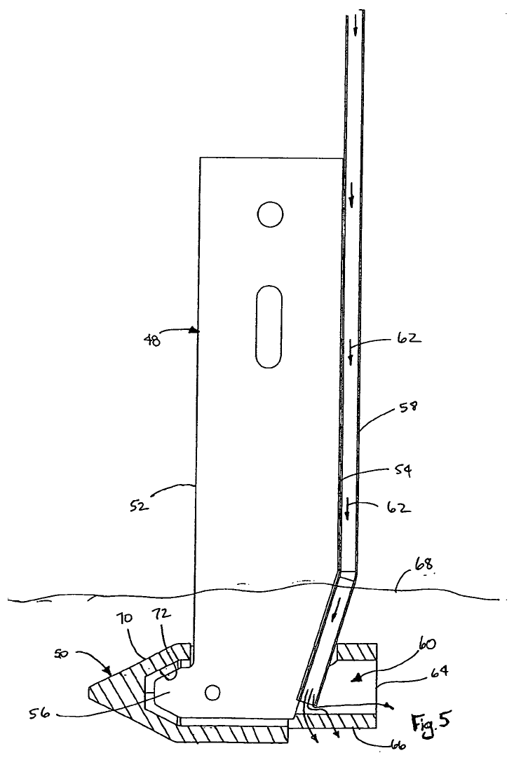

Extending downwardly from frame 12 is a pair of vertically oriented support brackets 44, 46, as shown, for example, in FIG. 2. Support brackets 44, 46 are positioned between first and second frame members 14, 16 and are adapted to be coupled to support arm 48. Support arm 48 is coupled to support brackets 44, 46 at a first end and coupled to a bullet-shape applicator 50 at a second end. Support arm 48 is positioned between first and second gage wheels 40, 42 and behind coulter wheel 34. Applicator 50 is shown coupled to support arm 48, as shown, for example, in FIG. 5.

Support arm 48 includes a leading edge 52 that faces coulter wheel 44 and a trailing edge 54, as shown, for example, in FIG. 5. Support arm 48 also includes a foot 56 that is adapted to be positioned within applicator 50. Positioned along the length of the trailing edge 54 of support arm 48 is an application conduit 58. Application conduit 58 extends along the length of support arm 48 and terminates within an internal cavity 60 of applicator 50. Fertilizer, pesticides, or other materials flow through the application conduit 58 in direction 62 and exit from application conduit 58 within internal cavity 60 out through openings 64, 66.

Applicator 50 is adapted to be positioned below ground level 68 within the trench formed by coulter wheel 44, as shown, for example, in FIG. 5. To limit soil disturbance, applicator 50 includes a tapered nose 70. Nose 70 of applicator 50 is illustrated in FIG. 5 as being conical in shape and is used to displace soil away from applicator 50 upon forward movement of agricultural dispensing assembly 10. Applicator 50 also includes a recess 72 adapted to accept foot 56 of support arm 48.

As soil treatment dispensing assembly 10 is moved in a forward direction, coulter wheel 34 penetrates the soil and forms a trench in the soil. Support arm 48 and applicator 50 are dragged through the trench created by coulter wheel 34. Movement of applicator 50 through the soil trench created by coulter wheel 34 forces the trench to widen around applicator 50 to allow fertilizer from application conduit 58 to be released from openings 64, 66 of applicator 50. Positioning openings 64, 66 at the bottom and rear of applicator 50 prevent soil from becoming packed within internal cavity 60 of applicator 50.

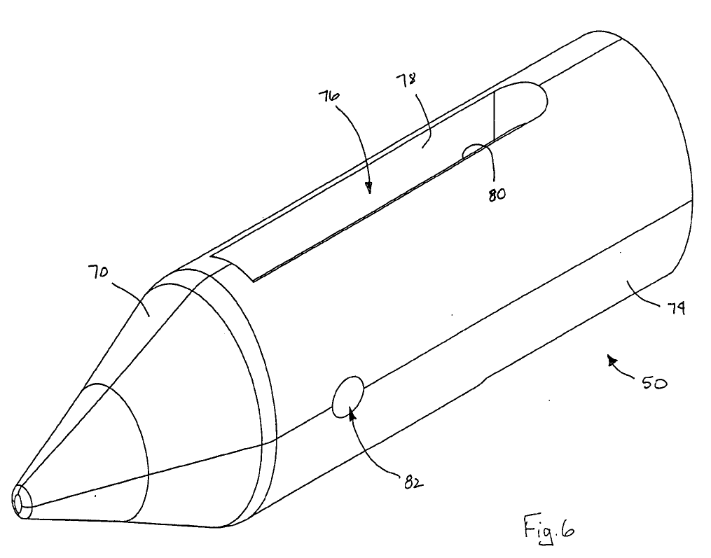

Applicator 50 includes an elongated body portion 74 that is tubular in shape and a conical nose 70, as shown, for example, in FIG. 6. Elongated body portion 74 includes slot 76 defined by walls 78, 80. Slot 76 is adapted to accept the lower portion of support arm 48 and application conduit 58. Elongated body portion 74 also includes aperture 82 that is adapted to accept a fastener to secure elongated arm 48 to applicator 50.

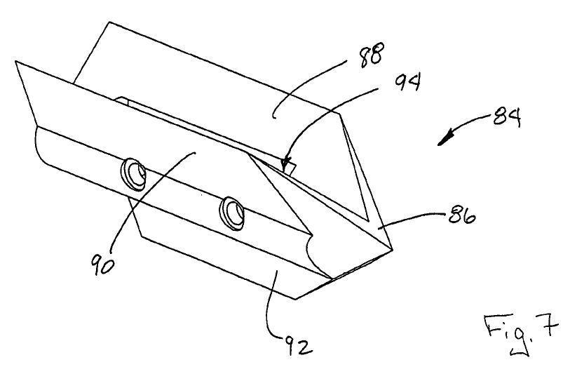

FIGS. 7 through 9 illustrate other embodiments of applicator 50. Applicator 84, shown in FIG. 7, includes a “V-shaped” nose 86 that lead into a pair of opposing wings 88, 90 and further includes a lower wing 92. The applicator 84 also includes a slot 94 adapted to accept support arm 48.

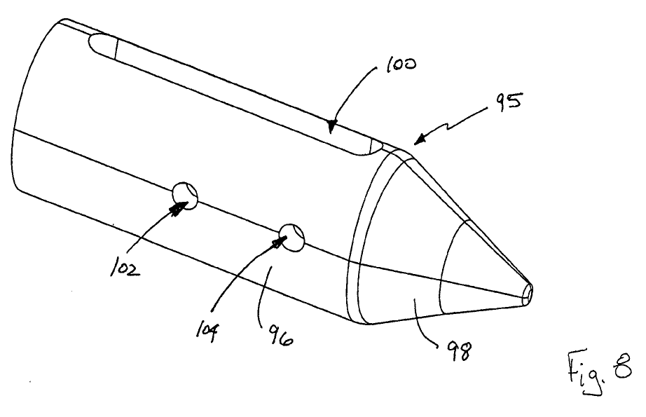

Applicator 95, as shown, for example, in FIG. 8, includes an oval shaped body portion 96 having a conical nose 98. Body portion 96 of applicator 95 has a vertical diameter that is longer than the horizontal diameter to form the oval shape. Applicator 95 also includes an elongated slot 100 formed in the top of body portion 96. Applicator 95 also includes a pair of apertures 102, 104, that are adapted to accept fasteners to secure support arm 48 to applicator 95.

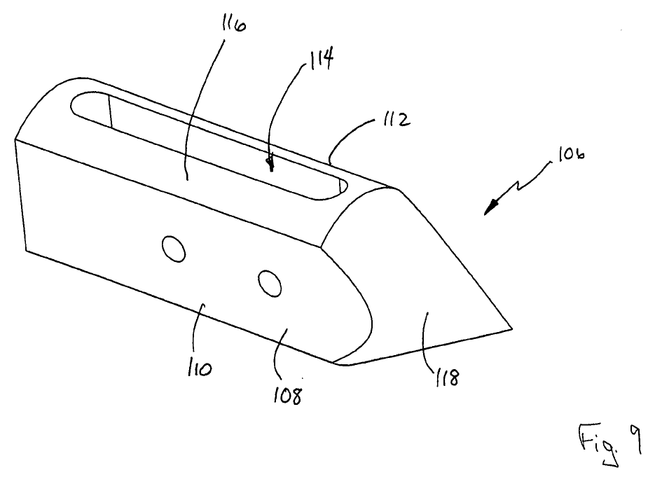

Applicator 106, as shown, for example, in FIG. 9, includes body portion 108 having a first planar side 110 and a second planar side 112. Body portion 108 also includes elongated slot 114 formed in a top surface 116 of body portion 108. Applicator 106 also includes a conical nose 118.

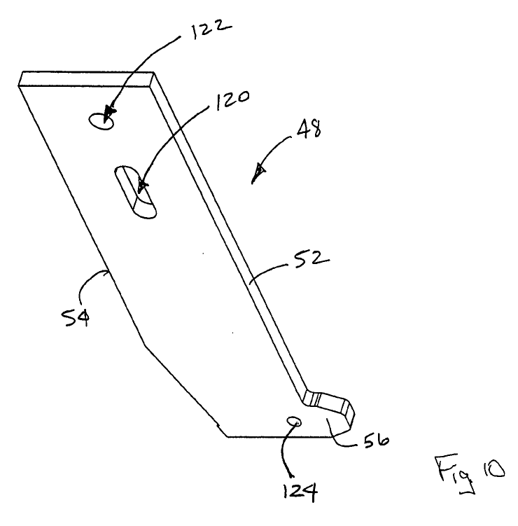

Elongated support arm 48 includes leading edge 52 and trailing edge 54 as shown, for example, in FIG. 10. Elongated support arm 48 includes an elongated slot 120 and an aperture 122 that are used with fasteners to secure elongated support arm 48 to support brackets 44, 46. The lower portion of support arm 48 includes foot 56 and aperture 124. Aperture 124 is adapted to accept fasteners to secure applicator 50 to support arm 48.

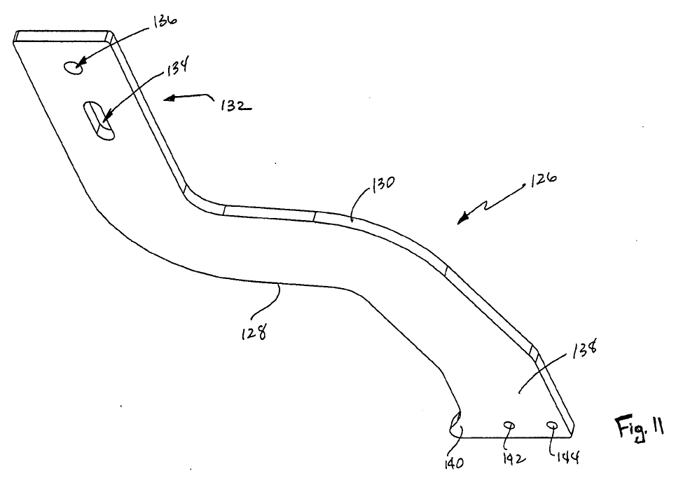

A variation of the support arm is shown in the illustrative embodiment of FIG. 11. Support arm 126 includes a curved leading edge 128 and a curved trailing edge 130. Upper portion 132 of support arm 126 includes elongated slot 134 and aperture 136 that are adapted to secure support arm 126 to support brackets 44, 46. Lower portion 138 of support arm 126 includes foot 140 adapted to be received within internal cavity 60 of applicator 50. Lower portion 138 also includes apertures 142, 144 adapted to accept fasteners to secure applicator 50 to support arm 126.

Soil treatment dispensing assembly 10 is used for high ground speed and provides for low soil disturbance during the application of liquid, granular and NH³ fertilizer in no till farming. Applicator 50 forms a narrow cavity under the soil surface for depositing fertilizer. The cavity formed in the soil is created by applicator 50 of support arm 48, which is adjustable to work with coulter wheels of varying diameter. The front of applicator 50 is generally tapered to gradually lift soil.

The sides of applicator 50 are elliptical shaped to reduce both draft and soil disruption. The applicator 50 includes slot 76 to permit the fertilizer to be deposited into cavity 60 of applicator 50. Fertilizer is delivered by application conduit 58 that is inserted through slot 76 of applicator 50 directly behind support arm 48. The elongated shape of applicator 50 holds open the cavity formed in the soil as fertilizer is being deposited. In addition, applicator 50 acts as a temporary sealing chamber for NH³ gas before the trench formed in the soil is closed.

The chamber formed in the soil by applicator 50 creates a shield to hold NH³ gas below the soil surface while the gage wheels 40, 42, directly above the soil chamber, seal off the soil surface. The arrangement is advantageous over knife applicators that depend on soil disruption to seal in the NH³. Gage wheels 40, 42 are vertically adjustable to vary the depth of soil treatment placement. In addition, the horizontal distance between the gage wheels 40, 42 is adjustable to concentrate the sealing action based on soil types.

The use of first and second support links 22, 24 permits soil treatment dispensing assembly 10 to float over the soil surface while maintaining a constant position of applicator 50 to the soil surface. The soil treatment dispensing assembly 10 can be mounted to the implement frame using a pivot mechanism which allows the coulter wheel 34 and applicator 50 to pivot horizontally side to side to follow row counters or with a non-pivot mechanism which locks the coulter wheel 34 and applicator 50 into a fixed position. Adjustable spring tension permits adjustment of the down force to achieve and maintain soil penetration by both the coulter wheel 34 and applicator 50. A residue managing device can be mounted to the front of the opener to move crop residue from in front of the coulter wheel 34.

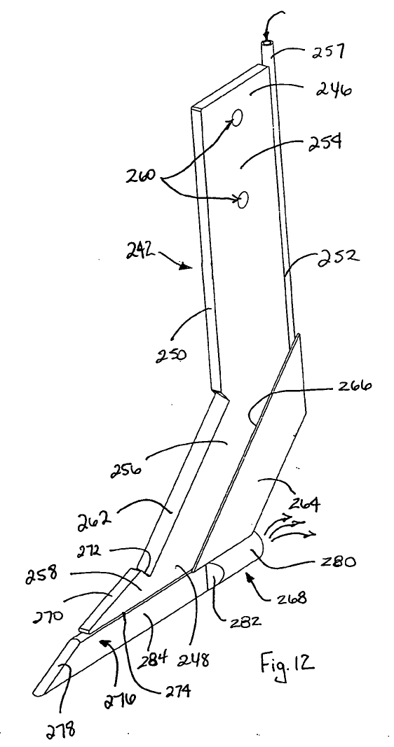

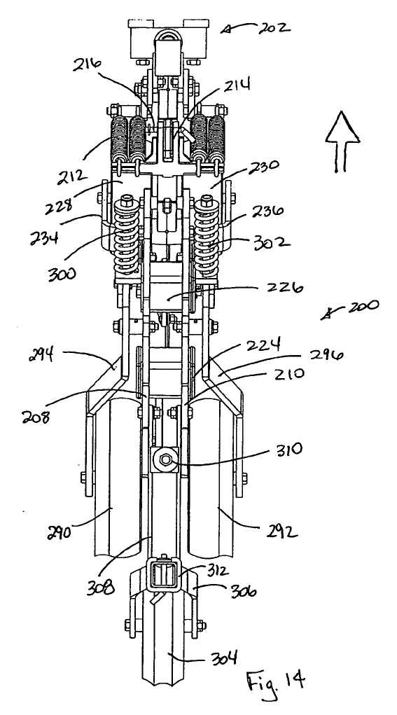

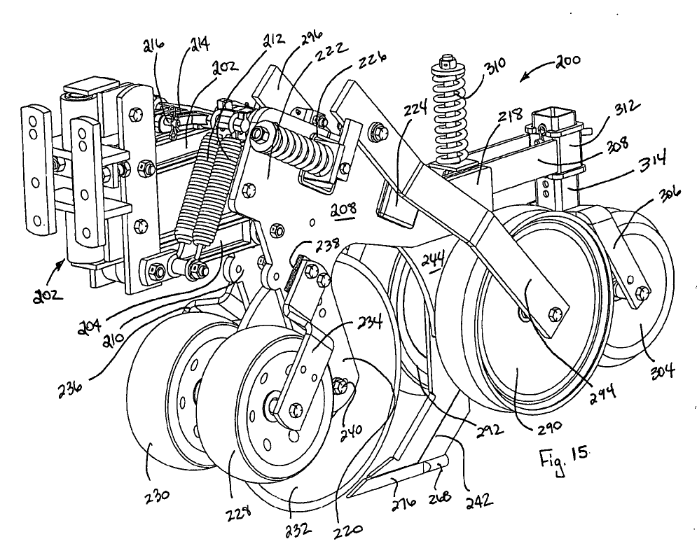

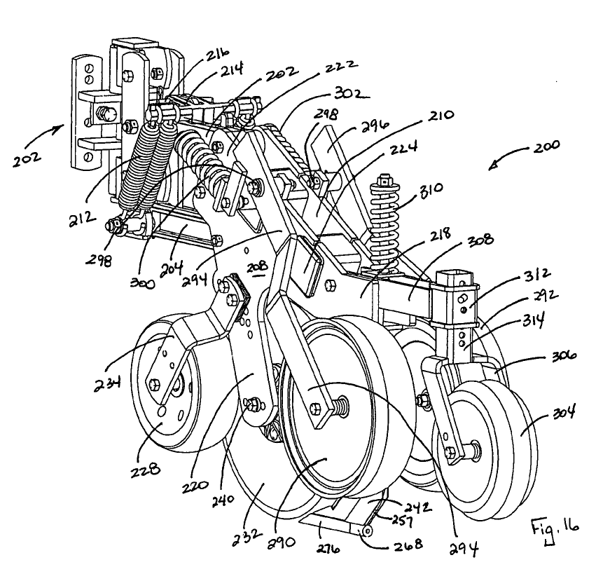

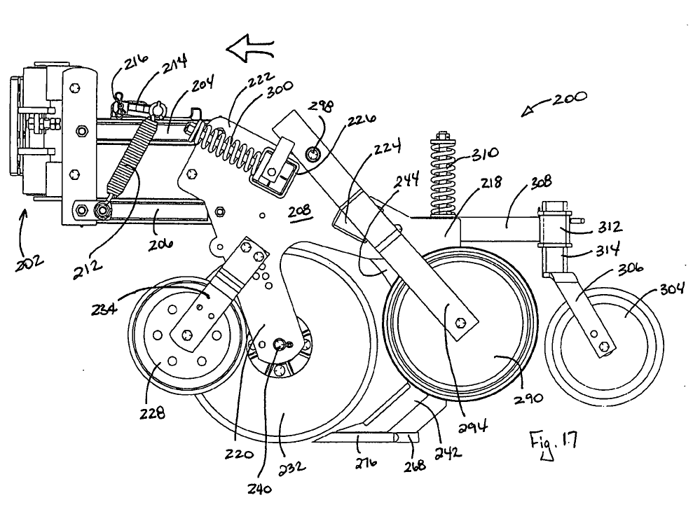

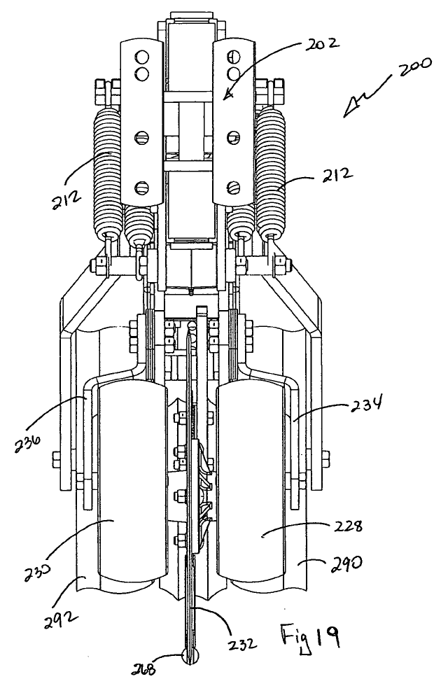

Another embodiment of the soil treatment dispensing assembly 200 is shown in FIGS. 12-20. Soil treatment dispensing assembly 200 includes a support bracket 202 that is adapted to be coupled to a support structure that is coupled to a tractor, as shown in FIG. 15. The support structure is adapted to support multiple soil treatment dispensing assemblies 200 behind the tractor. Support bracket 202 includes first and second support links 204, 206.

First and second support links 204, 206 are horizontally oriented and arranged parallel to one another, as shown in FIG. 15. First and second support links 204, 206 are coupled to the support bracket 202 at a first end and to first and second frame members 208, 210 at a second end. First and second support links 204, 206 permit movement of first and second frame members 208, 210 in a vertical direction. Movement of first and second frame members 208, 210 allows the soil treatment dispensing assembly 200 to move vertically to adjust to the terrain. Downward force is applied to first and second frame members 208, 210 by use of springs 212. While springs 212 are shown, pneumatics, such as pneumatic cylinders can be used to apply a downward force to the first and second frame members 208, 210.

The force applied to the frame members 208, 210 can be adjusted by adjusting down force bracket 214. Down force bracket 214 includes an adjustment pin 216. Adjustment pin 216 can be positioned in several apertures (not shown) to adjust down force on frame members 208, 210.

First and second frame members 208, 210 are y-shaped and include a rear leg 218, a bottom leg 220, and a forward leg 222, as shown in FIGS. 15-18. First and second frame members 208, 210 are separated by first and second interconnecting members 224, 226. First and second interconnecting members 224, 226 are rectangular members that are secured to the first and second frame members 208, 210 by welding or use of fasteners and maintain the spacing between members 208, 210.

Bottom legs 220 of first and second frame members 208, 210 extend in a downwardly direction and support gage wheels 228, 230 and coulter wheel 232, as shown in FIG. 15. Gage wheels 228, 230 are used to control the depth of coulter wheel 232 and are coupled to first and second frame members 208, 210 by gage brackets 234, 236. Gage brackets 234, 236 can be adjusted outwardly by use of shims 238. Coulter wheel 232 is coupled to bottom legs 220 by use of fastener 240. Positioned behind coulter wheel 232 is L-shaped support arm 242.

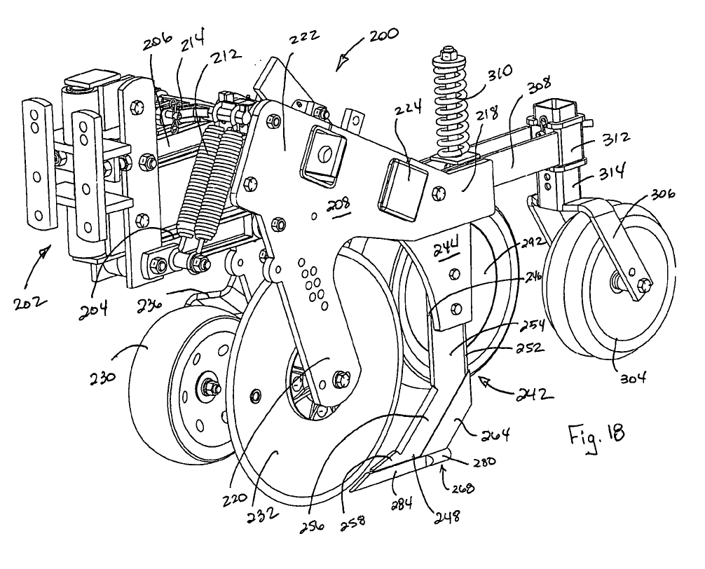

Support arm 242 is positioned behind coulter wheel 232 and includes a first end 246 coupled to support bracket 244 and a second free end 248, as shown in FIGS. 12 and 18. Support arm 242 also includes a leading edge 250 and a trailing edge 252. Support arm 242 includes a leg portion 254, a foot portion 256, and a toe portion 258. The leg portion 254 is generally vertical and includes apertures 260 that are adapted to accept fasteners to allow support arm 242 to be coupled to support bracket 244. Trailing edge 252 of leg portion 254 includes application conduit 257 that extends downwardly to applicator 268. Applicant conduit 257 is adapted to transfer fertilizer from a fertilizer supply line to applicator 268 to allow for the distribution of fertilizer beneath the surface of the soil.

Foot portion 256 of support arm 242 is positioned below leg portion 254 and includes an angled face 262 positioned along one edge of foot portion 256, as shown in FIG. 12. Angled face 262 engages the soil as support arm 242 moves through the soil behind coulter wheel 232. Foot portion 256 also includes a pair of wear plates 264 that extend along a rear edge 266 of foot portion 256. Wear plates 264 are preferably secured to foot portion 256 by welding. Wear plates 264 aid in protecting application conduit 257.

Toe portion 258 of support arm 242 is a triangular region that includes angled face 270, back face 272 and bottom edge 274, as shown in FIG. 12. Angled face 270 assists in keeping support arm 242 in the soil when the agricultural dispensing assembly 200 is moving in a forwardly direction. Support arm 242 also includes a skid plate 276 that is coupled to bottom edge 274 of toe portion 258. Skid plate 276 includes an angled face 278 and one end and applicator 268 at a second end.

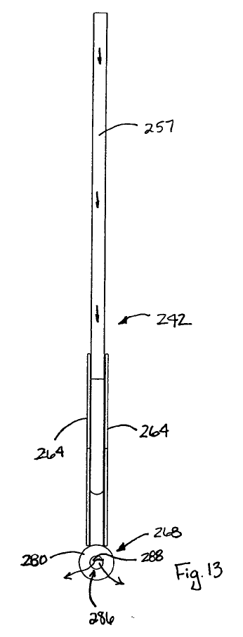

Applicator 268 is a tubular structure having a cylindrical side wall 280 and a sloped end 282 that tapers into side wall 284 of skid plate 276, as shown in FIGS. 12 and 13. Applicator 268 includes an opening 286 that leads to an interior chamber 288. Opening 286 acts as an exit port that is adapted to allow for the release of fertilizer or other treating substance. The interior chamber is defined by side wall 280. Application conduit 257 is coupled to interior chamber 288 of applicator 268 to allow liquid fertilizer or other soil treatment material to flow from application conduit 257 into interior chamber 288 and out of opening 286 to fertilize or otherwise condition the soil.

Soil treatment dispensing assembly 200 also includes a pair of soil disruption wheels 290, 292 that are positioned to the right and left side of support arm 242, as shown in FIG. 15. Soil disruption wheels 290 reduce the displacement of the top soil caused by the support arm 242 as the support arm 242 cuts through the soil. Soil disruption wheels 290 are positioned to the right and left of an invisible center line formed by coulter wheel 232 and support arm 242. Soil disruption wheels 290 are supported by support legs 294, 296. Support legs 294, 296 are pivotally coupled to first and second frame members 208, 210 by use of fasteners 298. Downward force is applied to support legs 294, 296 by use of spring assemblies 300, 302. Spring assemblies 300, 302 allow a user to adjust the downward force that is applied to the soil disruption wheels 290. While spring assemblies 300, 302 are shown, pneumatics, such as pneumatic cylinders can be used to apply a downward force to the soil disruption wheels 290.

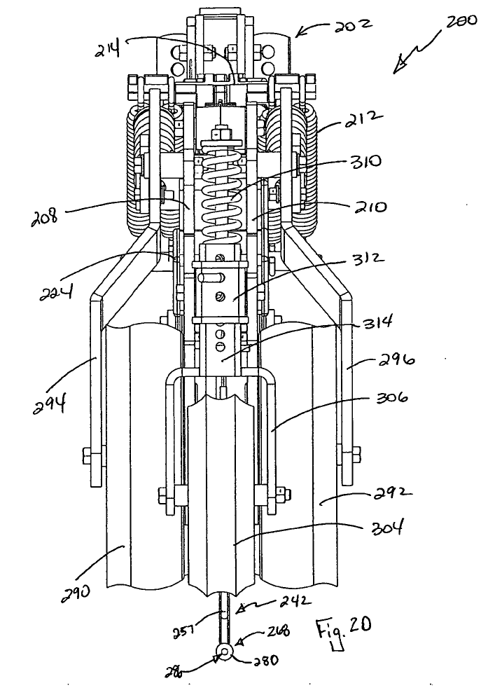

Positioned behind soil disruption wheels 290, 292 is seal wheel 304, as shown in FIGS. 15 and 20. Seal wheel 304 rides behind coulter wheel 232 and support arm 244 to close the trench formed in the soil. Seal wheel 304 is coupled to castor 306, which is releasably coupled to fork member 308. Fork member 308 is pivotally coupled to first and second frame members 208, 210. Downward force is applied to fork member 308 by use of spring assembly 310. Spring assembly is adjustable to allow for variation in the downward force that is applied to seal wheel 304. Fork member 308 includes a receiver tube 312 that is adapted to receive post 314 of castor 306. Post 314 includes a series of apertures that allow for vertical adjustment of seal wheel 304. While spring assembly 310 is shown, pneumatics, such as pneumatic cylinders can be used to apply a downward force to the seal wheel 304 in place of the springs. Hydraulic cylinders could also be used.

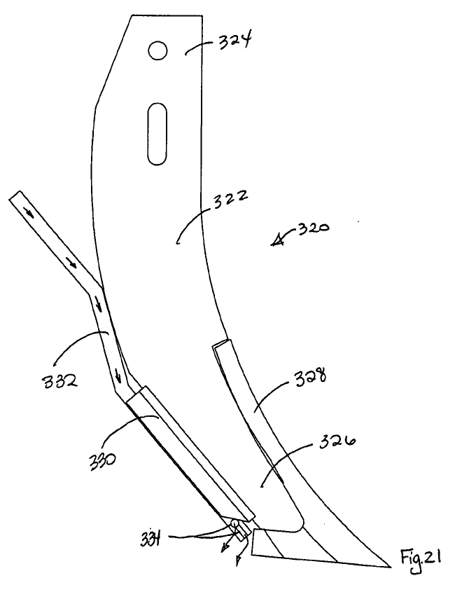

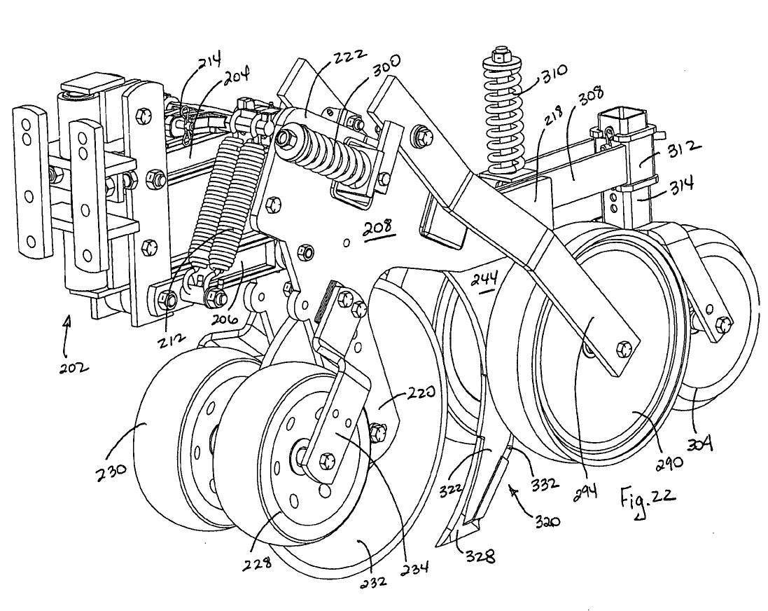

Knife 320 can also be coupled to soil treatment dispensing assembly 200, as shown in FIGS. 21 and 22. Knife 320 includes body 322 having an upper end 324 and a lower end 326. Knife 320 also includes a front wear plate 328 and a rear wear plate 330. Knife 320 further includes application conduit 332. Rear wear plate 330 is a channel shaped member that adapted to protect application conduit 332 during use of knife 320. Application conduit 332 includes openings 334 that are adapted to release fertilizer or other treating liquid. Knife 320 can be used with soil treatment dispensing assembly 200, as shown in FIG. 22.

Various features of the invention have been particularly shown and described in connection with the illustrative embodiments of the invention, however, it must be understood that these particular arrangements merely illustrate, and that the invention is to be given its fullest interpretation within the terms of the appended claims.

1. A soil treatment dispensing assembly adapted to be coupled to a motive power source and pulled in a forward direction over a field to treat soil, said soil treatment dispensing assembly comprising:
a frame;
a coulter wheel coupled to said frame, said coulter wheel adapted to engage the soil to form a trench;
a support arm having a leading edge and a trailing edge, said support arm coupled to said frame and positioned rearwardly of said coulter wheel, at least a portion of said support arm positioned to pass through the trench created by said coulter wheel;
a soil treatment applicator secured to a lower portion of said support arm;
said soil treatment applicator including a dispensing opening; and
an application conduit in communication with said soil treatment applicator, said application conduit connectable to a source of treating product for communicating the treating product to said soil treatment applicator to allow the treating product to exit said dispensing opening formed in said soil treatment applicator to treat the soil.

2. The soil treatment dispensing assembly of claim 1, wherein said soil treatment applicator includes a cylindrical body portion that is adapted to form an internal cavity within said soil treatment applicator.

3. The soil treatment dispensing assembly of claim 2, wherein said dispensing opening and said application conduit are in communication with said internal cavity to allow the treating product to flow from the application conduit to said dispensing opening.

4. The soil treatment dispensing assembly of claim 3, wherein said soil treatment applicator includes a tapered forward region positioned to lie near said cylindrical body portion.

5. The soil treatment dispensing assembly of claim 2, wherein the soil treatment applicator is coupled to the trailing edge of the support arm.

6. The soil treatment dispensing assembly of claim 1, furthering including a pair of soil disruption wheels positioned to lie near the coulter wheel that are adapted to engage the soil.

7. The soil treatment dispensing assembly of claim 6, wherein the soil disruption wheels include a concave perimeter surface.

8. The soil treatment dispensing assembly of claim 6, further including a seal wheel positioned behind the soil disruption wheels, said seal wheel adapted to engage the soil.

9. The soil treatment dispensing assembly of claim 6, further including a pair of gage wheels positioned to lie near said coulter wheel and adapted to assist in controlling the depth at which said coulter wheel penetrates the soil.

10. A soil treatment dispensing assembly adapted to be coupled to a motive power source and pulled in a forward direction over a field to fertilize soil, said soil treatment dispensing assembly comprising:
a frame;
a coulter wheel associated with said frame, said coulter wheel adapted to engage the soil to create a trench;
a support arm associated with the frame and positioned rearwardly of said coulter wheel;
a soil treatment application conduit associated with said support arm and adapted to dispense treating product directly into the trench created by said coulter wheel; and
a pair of soil disruption wheels positioned to lie near said coulter wheel, said soil disruption wheels arranged to engage the soil displaced by said coulter wheel.

11. The soil treatment dispensing assembly of claim 10, wherein the soil disruption wheels include a concave perimeter.

12. The soil treatment dispensing assembly of claim 11, further including a biasing member adapted to apply a biasing force to said soil disruption wheels.

13. The soil treatment dispensing assembly of claim 11, further including a seal wheel positioned behind the soil disruption wheels, said seal wheel adapted to engage the soil.

14. The soil treatment dispensing assembly of claim 13, further including a biasing member adapted to apply a biasing force to said seal wheel.

15. The soil treatment dispensing assembly of claim 11, further including a pair of gage wheels positioned to lie near said coulter wheel and adapted to assist in controlling the depth at which said coulter wheel enters the soil.

16. The soil treatment dispensing assembly of claim 15, furthering including a biasing member adapted to apply a biasing force to said gage wheels.

17. The soil treatment dispensing assembly of claim 10, wherein the support arm is positioned along a center line and said soil disruption wheels are positioned to the sides of the center line.

18. A soil treatment dispensing assembly for dispensing a soil treatment product into a trench formed in the soil, said soil treatment dispensing assembly comprising:
a support member adapted to position said dispensing assembly within the trench formed in the soil;
a soil treatment applicator coupled to said support member and formed to include an internal cavity, said soil treatment applicator adapted to be positioned in the trench;
an exit port formed in said soil treatment applicator, said exit port is in communication with said internal cavity and adapted to allow soil treatment product to exit said applicator into the trench and is shielded by said side wall from soil that has been displaced by movement of said soil treatment applicator through the trench in the soil.

19. The soil treatment dispensing assembly of claim 18, further including an application conduit that is in communication with said internal cavity and is adapted to allow the treating product to flow from the application conduit to said exit port.

20. The soil treatment dispensing assembly of claim 19, wherein said soil treatment applicator includes a tapered forward region that is adapted to deflect soil.

21. The soil treatment dispensing assembly of claim 18, wherein the soil treatment applicator is secured to said support member.

22. The soil treatment dispensing assembly of claim 19, wherein said application conduit is in communication with said soil treatment applicator.
